(19) United States
(12) Patent Application Publication
(10) Pub. No.: US 2016/0155039 A1
(43) Pub. Date: Jun. 2, 2016

(54) Electronic Chip Card

(71) Applicants: Peter-Joachim NEYMANN, Recklinghausen (DE); Christoph MUHLHAUSE, Wangen im Allgau (DE)

(72) Inventors: Peter-Joachim NEYMANN, Recklinghausen (DE); Christoph MUHLHAUSE, Wangen im Allgau (DE)

(21) Appl. No.: 14/905,449

(22) PCT Filed: Jul. 16, 2014
(86) PCT No.: PCT/EP2014/065208

§ 371 Date: Jan. 15, 2016

(30) Foreign Application Priority Data
Jul. 16, 2013 (DE) 10 2013 011 812.3

(51) Int. Cl. G06K 19/07

(52) U.S. Cl. CPC G06K 19/0718

(57) ABSTRACT

The invention relates to an electronic chip card having a multilayer structure, comprising
a system carrier (1), which comprises an electrically insulating substrate with interconnects (2) arranged thereon,
cover layers (3, 4) arranged on the top and bottom of the system carrier,
a biometric sensor (18), and
a semiconductor component (19) that is designed to evaluate the signals from the biometric sensor (18) and to store biometric data, wherein the semiconductor component (19) is electrically conductively connected to one or more interconnects (2) of the system carrier (1). It is the object of the invention to provide an electronic chip card having a biometric sensor (18), which electronic chip card allows a relatively large number of electronic components to be accommodated on the system carrier (1) of the chip card. Furthermore, the electronic chip card is intended to be able to be produced as easily and inexpensively as possible and in relatively large numbers. This object is achieved by the invention by virtue of the semiconductor component (19) and the biometric sensor (18) being arranged in a common housing (22) that contains the semiconductor component (19) beneath the biometric sensor (18), wherein the semiconductor component (19) with the biometric sensor (18) forms a biometry module (11).

The invention relates to an electronic chip card having a multilayer structure, comprising
a system carrier, which comprises an electrically insulating substrate with interconnects arranged thereon,
cover layers arranged on the top and bottom of the system carrier,
a biometric sensor, and,
a semiconductor component that is designed to evaluate the signals from the biometric sensor and to store biometric data, wherein the semiconductor component is electrically conductively connected to one or more interconnects of the system carrier.

Following the magnetic stripe cards, electronic chip cards become increasingly important. The essential difference as compared to magnetic stripe cards lies in that electronic chip cards comprise electrical and electronic components, in particular semiconductor components. Another commonly used designation is the term “smart card”.

An electronic chip card of the initially described kind is known from WO 2013/019701 A1. With the prior art electronic chip card, a system carrier is disposed on which various electronic components are arranged, including but not limited to a biometric sensor which, for example, may be a fingerprint sensor. A microcontroller to control and query the biometric sensor and to store biometric data, for example fingerprint data, is also arranged on the system carrier, that means laterally staggered from the biometric sensor. Furthermore, an energy supply circuitry is provided to supply energy to the biometric sensor and to the microcontroller. The energy supply circuitry preferably comprises an induction antenna that receives high-frequency electromagnetic fields from the environment of the chip card, wherein the induction voltage is utilized for energy supply. The prior art electronic chip card comprises a multilayer structure, wherein the system carrier with the electronic components arranged on it is embedded between cover layers arranged at the top and bottom side of the system carrier.

A disadvantage of the prior art electronic chip card is that the required components (biometric sensor, microcontroller, energy supply circuitry) call for comparably substantial space on the system carrier, thus leaving only little or no space for other components. Therefore, the actually known concept of an electronic chip card with a biometric sensor is hitherto only available for a very limited number of applications.

Against this background, it is the object of the present invention to provide an electronic chip card with a biometric sensor that allows for accommodating a major number of electronic components on the system carrier of the chip card. Furthermore, the electronic chip card should be producible as simply and cost efficiently as possible, and in larger numbers.

The present invention achieves this object, proceeding from an electronic chip card of the afore-mentioned kind in that the semiconductor component and the biometric sensor are arranged one above the other, preferably in a common housing, in which the semiconductor component is located beneath the biometric sensor, wherein the semiconductor component with the biometric sensor forms a biometry module.

The core idea of the present invention is combining the biometric sensor with the semiconductor component (for example in form of a microcontroller) needed for its controlling and querying in a compact module. To demand as little card area as possible, the semiconductor component is located beneath the biometric sensor. It means the areas of the biometric sensor and of the semiconductor component—viewed in a direction vertical to the plane of the chip card—overlap each other wholly or partly (preferably for the largest part).

Typically, the biometric sensor at its top side has a sensor surface via which the biometric data of a card user are acquired. For example, temperature-sensitive or pressure-sensitive or optical sensor elements (for example transistors) are arranged at the sensor surface in a matrix or line-shaped configuration. To scan the characteristic skin groove pattern of a fingerprint, a card user lays its finger on the sensor surface or draws its finger over the sensor surface, depending on whether a matrix sensor or a line sensor are built-in. The sensor data are transmitted to the semiconductor component of the biometry module via suitable electrical connections. The semiconductor component evaluates the sensor data and compares them with stored biometric data of the card owner.

The sensor surface must be freely accessible at the card surface to enable acquisition of biometric data. The semiconductor component for controlling and querying the biometric sensor is inventively arranged beneath the sensor so that the card area demanded by the biometric sensor is utilized in multiple ways, that means not only for the sensor surface but also for the electronic components for controlling and querying the biometric sensor.

If the acquired sensor data are identical to the stored biometric data, the semiconductor component generates a signal that indicates authentication. This can be utilized to release certain functions of the chip card, such as for example a query of the user's personal data that are stored on the card. This is advantageous for the use of the card as a “health card” in the medical field. In this case, the user's personal data may relate to medical data such as for example data on previous diseases or on a medication of the card owner. The data may also relate to a patient decree. Authentication can also be utilized advantageously in other fields, for example in order to release financial transactions.

In a preferred embodiment of the present invention, the biometric sensor, as has already been mentioned before, is a fingerprint sensor, wherein the cover layer at the top or bottom side in the area of the sensor surface of the fingerprint sensor has a recess. Through the recess in the cover layer, the sensor surface at the surface of the chip card becomes accessible, thus enabling acquisition of biometric data, like fingerprint data in this case. The recess in the cover layer furthermore makes it possible to insert (“to implant”) the biometry module when producing the chip card, after the system carrier has been connected to the cover layers (for example by hot laminating). In this manner, the biometry module with the possibly sensitive sensor elements is not exposed to high temperatures occurring on lamination. The sensitive biometry module is subsequently inserted through the recess in the cover layer and electrically conductively connected in a suitable manner to the designated interconnects of the system carrier.

In another preferred embodiment of the inventive electronic chip card, an induction antenna is provided for as well as an energy storage element and an energy supply circuitry linked to the induction antenna and the at least one energy storage element. This assures energy supply to the biometry module which is independent from a battery or any other energy source. It is advantageous that the biometry module can be utilized for authentication without connecting the chip card to a card reader device. This assures special safety. A chip card user can perform authentication for example by way of its fingerprint and thereby release the card which can only afterwards be read-out by means of a reader device in order to query the data stored on the card. The autonomous function of the biometry module assures that the biometric data stored in the biometry module cannot be read-out via the reader device, because the card can physically be so configured that no data link can be established between the biometry module and the reader device. Eligible for use as energy storage element, for example, is an arrangement comprised of one or several capacitors which can be accommodated on the system carrier in a space-saving manner and be connected electrically conductively via interconnects of the system carrier. In a preferred embodiment, the induction antenna can be formed by interconnects of the system carrier.

Suitable as an alternative to the induction antenna for supplying energy to the biometry module is a solar element that converts light falling onto the card surface into an electric voltage.

In an especially preferred embodiment of the inventive electronic chip card, the energy supply circuitry is arranged in the common housing of the biometry module and thus it forms an integral part of the biometry module. With special preference, the energy supply circuitry like the semiconductor component, too, which serves for evaluating the signals from the biometric sensor, is located beneath the biometric sensor. Accordingly, the biometry module is preferably built-up in three planes, whereof the uppermost plane forms the biometric sensor, while the two planes lying underneath are formed by the semiconductor component for controlling and querying the biometric sensor on the one hand and by the energy supply circuitry on the other hand. The planes can each be realized by application-specific integraded circuits (ASIC) which are contacted in vertical direction (vertical to the card plane) among each other directly via bond connections. An essential advantage is the little space requirement of the biometry module realized in this manner. Another benefit is achieved in that only one interface to the remaining periphery arranged on the chip card is needed, for example one single serial interface to link the biometry module to a central microcontroller of the chip card.

In another specific embodiment, the biometry module is located within a recess of the system carrier. In case the biometry module requires a lot of space in vertical direction, that means vertical to the plane of the chip card, due to its construction height, it may be provided for that the system carrier has a recess into which the biometry module is then inserted. With this configuration, the biometry module may protrude beyond the system carrier at top and bottom. By way of a suitable contouring of the upper and lower cover layers that is complimentary to the shape of the biometry module, the chip card may be so configured that with normal thickness (according to the ISO standard applicable to chip cards) it accommodates the biometry module.

With special preference, a fingerprint sensor integrated on a semiconductor substrate is used as biometric sensor. So-called “wafer level” fingerprint sensors, e.g. in CMOS technology, with modularly integrated pixel matrix, querying electronics, and interface components are commercially available. To integrate them into the inventive biometry module without the thickness of the biometry module and thus the thickness of the card exceeding the limit values of the ISO standard, the semiconductor substrate of the fingerprint sensor can be reduced in thickness from the rear side of the wafer to a minimum of a few 100 μm or even to less than 100 μm, for example by grinding or etching. This does not detrimentally affect the function of the fingerprint sensor.

Preferably the inventive electronic chip card has a contact module with electrical contacts arranged at a contact area, wherein the cover layer at top or bottom in the area of the contact area has a recess. The contact module serves for contacting the electronic chip card in a reader device of a conventional type. Such a reader device, as has been outlined hereinabove, can be utilized in order to read-out data stored on the chip card after authentication through the biometric sensor.

Furthermore, the electronic chip card preferably comprises a microcontroller which is connected through one or several interconnects each of the system carrier to the contact module on the one hand and to the biometry module on the other hand. The microcontroller may be a microcontroller which is commonly applied in chip cards. According to the present invention, this microcontroller is linked to the biometry module in order to be able to execute the afore-mentioned authentication before the owner's data stored in the microcontroller can be queried through the reader device.

With another preferred embodiment of the inventive electronic chip card, a display integrated into the card is provided for. Data displays that can be integrated into electronic chip cards are actually known from prior art in technology. These can be utilized with advantage for the inventive electronic chip card in order to display data stored on the chip card after authentication by means of the biometric sensor, that means without the need for a reader device. This configuration assures special safety, because it can be entirely prevented that data stored on the chip card leave the card in any manner on an electronic path. Moreover, a configuration of the chip card with an integrated display is advantageous for applications in medical fields. Data stored on the card, such as for example data concerning previous diseases or a medication, can be made available in a case of emergency, even though there is no suitable reader device available. On account of the large area, the integrated display calls for substantial space on the chip card. The configuration of the inventive biometry module which, as has been outlined hereinabove, calls for especially little space on the chip card, allows for providing a combination of a biometric sensor with a display on a chip card. On account of the compact structure of the biometry module, sufficient space is kept available not only for the display itself, but also for a battery or a similar energy supply with sufficient capacity to operate the display.

As has been outlined hereinabove, the inventive card can be produced by laminating. Through the laminating process, the different layers of the chip card, i.e. the system carrier with the electronic components arranged thereon or connected thereto, and the upper and lower cover layers are connected with each other solidly, i.e. non-detachably. Initially, on producing the inventive electronic chip card, the system carrier is produced preferably by etching a metallically coated, electrically insulated plate or foil. Subsequently, those electronic components which are directly connected with the system carrier are applied (e.g. the central microcontroller of the card). Then, the upper and lower cover layers which are possibly comprised of several layers are attached at the top and bottom side of the system carrier. One or several structurized intermediate layers may be provided for which offset the surface contour of the system carrier including electronic components arranged thereon and/or connected thereto. This pile of layers is then transformed by hot lamination into a solid compound. In a next step, the recesses, for example for the biometry module and the contact module, are milled into the upper and/or lower cover layer. Finally, the biometry module and the contact module are “implanted” into the relevant recesses. The chip card is thus completed. For individualization, the upper and lower cover layers, as is common practice for electronic chip cards, can be imprinted in advance in a suitable manner. Lamination can be executed through hot lamination, wherein the layers are thermally bonded at hot temperature by way of an adhesive which is solid at normal temperature and which is arranged between the layers. However, it is of special advantage to apply a cold laminating technique in which an adhesive is utilized that is curable at normal temperature, i.e. without any temperature impact. In cold laminating, the electronic components of the chip card are not exposed to elevated temperatures and therefore, they are less susceptible to suffer from damages than they would be in hot lamination. Besides, the option is given to connect the biometry module and the contact module with the system carrier already prior to the laminating process.

In another preferred embodiment of the inventive card, an acoustic or optical signal transmitter, e.g. a piezoelectrical signal transmitter or a light-emitting diode (LED) connected to the biometry module may be provided for that accordingly signalizes a successful or unsuccessful authentication procedure.

With further preference, tactile or haptic features may be arranged on the card surface in the area of the biometric sensor which are perceived by a user of the card through the sense of touch and thus lead the user to the biometric sensor. Thereby it is possible to safely operate the fingerprint sensor, that means even in the dark or if the card owner's sense of sight is adversely affected.

Practical examples of the present invention are elucidated in the following by way of drawings, where:

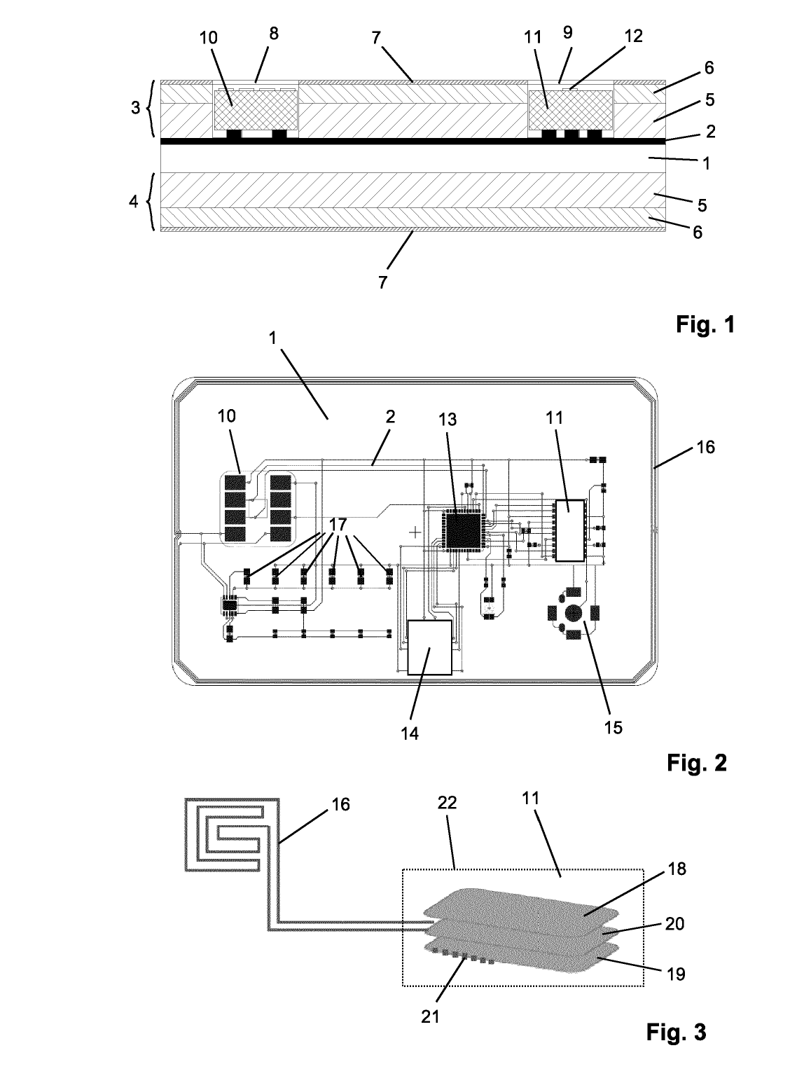

FIG. 1: is a sectional side view of an inventive electronic chip card;

FIG. 2: is a plan view on the system carrier of the inventive electronic chip card with electronic components arranged thereon;

FIG. 3: is a schematic view of the biometry module of the inventive chip card with induction antenna.

FIG. 1 shows a practical example of the inventive electronic chip card schematically in a sectional side view. The structure of the chip card comprises a system carrier 1, which has electrically conductive interconnects 2 at its top side. System carrier 1 with interconnects 2 can be produced, for example, by etching a metallized foil. Arranged at the top and bottom side of system carrier 12 are cover layers 3 and 4. They have a multiple layer build-up each. The build-up is comprised of a spacer 5, a printing foil 5, and a protective coating 7 each. To offset the contour of system carrier 1 including the electronic components arranged thereon, spacer 5 itself may have a multiple-layer structure (not illustrated). For individualization of the chip card, printing foil 6 can be arbitrarily imprinted. Protective coating 7 serves for providing mechanical protection to printing foil 6. If required, protective coating 7 also comprises an UV protection to prevent the print on printing foil 6 from bleaching-out. Cover layer 3 at the top side of the card has recesses 8 and 9 which on production are brought into the cover layer 3, for example by milling or punching. Arranged in recess 8 is a contact module 10 which is connected to the electrical interconnects 2. At its surface, contact module 10 has electrodes for establishing an electrical contact of the card with a relevant reader device. Located in recess 9 is a biometry module 11 which inventively is comprised of a biometric sensor and a semiconductor component configured to evaluate signals from the biometric sensor and to store biometric data. The biometric sensor and the semiconductor component are accommodated in a common housing, with the semiconductor component being arranged beneath the biometric sensor. In this practical example, the biometric sensor is a fingerprint sensor, at the sensor surface of which temperature-sensitive or pressure-sensitive elements 12 are arranged in order to scan the skin groove pattern of a fingerprint. The biometry module 11, like the contact module 10, too, is electrically conductively connected at its bottom side to the electrical interconnects 2 of system carrier 1.

FIG. 2 shows a plan view on system carrier 1 of the inventive electronic chip card. In addition to the interconnects 2, contact module 10, and biometry module 11, the plan view still shows a central microcontroller 13 which through interconnects 2 of system carrier 1 is connected to contact module 10 on the one hand and to biometry module 11 on the other hand. Furthermore, one can see a debug module 14 which is provided for testing and debugging the chip card. Debug module 14 can be contacted, for example via needle electrodes, to an external device. A pushbutton 15 serves for activating the biometry module 11 through the card owner. An induction antenna 16 is formed through interconnects of the system carrier. The induction antenna 16 is configured as a frame antenna bordering the edge of system carrier 1. Capacitors 17 are provided for as energy storage elements which are loaded with the induction voltage of the induction antenna 16 and thus charged. Via a suitable energy supply circuitry, the biometry module 11 is supplied with energy from capacitors 17.

FIG. 3 schematically shows the inventive biometry module 11. Arranged in three planes one above the other therein are the biometry sensor (fingerprint sensor) 18, the semiconductor component 19, which serves to evaluate the signals from the biometric sensor 18 and to store biometric data, and the energy supply circuitry 20. It means the areas of biometric sensor 18, semiconductor component 19, and energy supply circuitry 20—viewed in a direction vertical to the plane of the chip card—overlap each other. The totally occupied area thus corresponds to the area of the largest one of the three elements 18, 19, 20. The elements 18, 19, and 20 which are arranged one above the other, are directly connected among each other (in vertical direction viewed to the chip card plane) via bond connections. Each of the three planes is formed by an application-specific integrated circuit (ASIC). In this practical example, the energy supply circuitry 20 is merely connected via two outwardly conducted contacts to the induction antenna 16. The semiconductor component 19 comprises contacts 21 of a serial interface. Contacts 21 can be connected directly to interconnects 2 of system carrier 1. Communication with microcontroller 13 during the authentication process is accomplished in this way. The common housing of biometry module 11 is indicated in FIG. 3 with reference number 22.

1. Electronic chip card having a multilayer structure, comprising:
a system carrier, which comprises an electrically insulating substrate with interconnects arranged thereon,
cover layers arranged on the top and bottom of the system carrier,
a biometric sensor, and
a semiconductor component that is designed to evaluate the signals from the biometric sensor and to store biometric data, wherein the semiconductor component is electrically conductively connected to one or more interconnects of the system carrier, wherein the semiconductor component and the biometric sensor are arranged one above the other, preferably in a common housing, wherein the semiconductor component is located beneath the biometric sensor, and wherein the semiconductor component with the biometric sensor forms a biometry module.

2. Electronic chip card according to claim 1, wherein the biometric sensor is a fingerprint sensor, wherein the cover layer at top and bottom in the area of a sensor surface of the fingerprint sensor has a recess.

3. Electronic chip card according to claim 1, further comprising an induction antenna or a solar element, at least one energy storage element, and an energy supply circuitry linked to the induction antenna or the solar element and the at least one energy storage element.

4. Electronic chip card according to claim 3, wherein the biometry module is supplied with energy through energy supply circuitry.

5. Electronic chip card according to claim 4, wherein the energy supply circuitry is arranged in the common housing and thus part of the biometry module.

6. Electronic chip card according to claim 2, wherein the induction antenna is formed by interconnects of system carrier.

7. Electronic chip card according to claim 1, wherein the biometry module is located within a recess of the system carrier.

8. Electronic chip card according to claim 1, further comprising a contact module with electrical contacts arranged at a contact surface, wherein the cover layer at top and bottom in the area of the contact surface has a recess.

9. Electronic chip card according to claim 8, further comprising a microcontroller which is connected via one or several interconnect(s) of system carrier on the one hand to contact module and on the other hand to biometry module.

10. Electronic chip card according to claim 9, further comprising a display via which data can be displayed that are stored in at least one of the microcontroller and the semiconductor component of the biometry module.

11. Electronic chip card according to claim 1, wherein the compound comprised of the top side and bottom side cover layer as well as system carrier is produced by laminating.

12. Electronic chip card according to claim 1, further comprising at least one structurized intermediate layer which offsets the surface contour of system carrier including electronic components arranged thereon and/or connected thereto.

13. Electronic chip card according to claim 1, further comprising an acoustic or optical signal transmitter connected to biometry module.

14. Electronic chip card according to claim 1, further comprising tactile or haptic features arranged on the card surface in the area of the biometric sensor.

15. Electronic chip card according to claim 1, wherein the biometric sensor is a fingerprint sensor integrated on a semiconductor substrate.
